(19) United States
(12) Patent Application Publication
(10) Pub. No.: US 2007/0003100 A1
(43) Pub. Date: Jan. 4, 2007

(54) Loudspeaker structure with a lighting effect

(75) Inventor: Chun I Liu, Taoyuan City (TW)

Correspondence Address: TROXELL LAW OFFICE PLLC, SUITE 1404, 5205 LEESBURG PIKE, FALLS CHURCH, VA, 22041, US

(73) Assignee: Mei Shan Electronic Co., Ltd.

(21) Appl. No.: 11/171,333

(22) Filed: Jul. 1, 2005

(51) Int. Cl. H04R 9/06

(52) U.S. Cl. 381/412

(57) ABSTRACT

A loudspeaker structure with a lighting effect includes a support frame having a magnetic circuit disposed at the bottom of the support frame, a voice coil installed above the magnetic circuit, a diaphragm adhered on the voice coil, and a suspending edge disposed between the diaphragm and the support frame, characterized in that the diaphragm is a thin object pervious to light, and a through hole is constructed separately at the front and rear ends of the magnetic circuit for receiving a light emitting device. After the loudspeaker is assembled, the light emitting device is installed in the interior space between the diaphragm and the magnetic circuit. Besides outputting sounds, the loudspeaker also produces a lighting effect, so as to make the manufacture and applications of the loudspeaker more diversified and allow the loudspeaker to have various changes.

### BACKGROUND OF THE INVENTION

1. Field of the Invention

The present invention relates to an improved loudspeaker, and more particularly to an easy-to-manufacture loudspeaker structure that installs a light emitting device in the space between a diaphragm and a magnetic circuit of the loudspeaker to produce sounds as swell as emitting lights from the interior of the loudspeaker.

2. Description of the Related Art

Referring to FIG. 1 for the traditional loudspeaker, its structural design only allows a monotonous output of sounds, but lacks of a visual effect. Therefore, a loudspeaker device having a lighting effect was disclosed in R.O.C. Pat. No. 397312, which comprises a box body, a vertical arc groove separately disposed on both sides of a panel or an arc ring groove disposed on a lateral side of the loudspeaker or a combination of both, for embedding a straight neon light or a circular neon light; a speaker or two speakers separately coupled to the panel of the box body; a light emitting device, comprised of a straight neon light, a lamp hood, and a plurality of elastic rings for connecting the straight neon light, or a combination of the previous two elements to be embedded into the arc groove or the arc ring groove of the panel of the box body. When the loudspeaker is in use, it can produce sounds as well as emitting a light beam or a light ring or both.

However, the light source of such design comes from the lateral side of the loudspeaker and cannot come from the interior of the loudspeaker, and thus the light and sound effects are limited.

In view of the shortcomings of the prior art, the inventor of the present invention based on years of experience in the related industry to conduct extensive researches and experiments, and finally invented a loudspeaker structure with a lighting effect in accordance with the present invention.

### SUMMARY OF THE INVENTION

The primary objective of the present invention is to design an easy-to-manufacture loudspeaker structure that installs a light emitting device in the space between a diaphragm and a magnetic circuit of the loudspeaker to produce sounds as swell as emitting light from the interior of the loudspeaker.

### BRIEF DESCRIPTION OF THE DRAWINGS

FIG. 1 is a schematic view of a prior art loudspeaker structure;

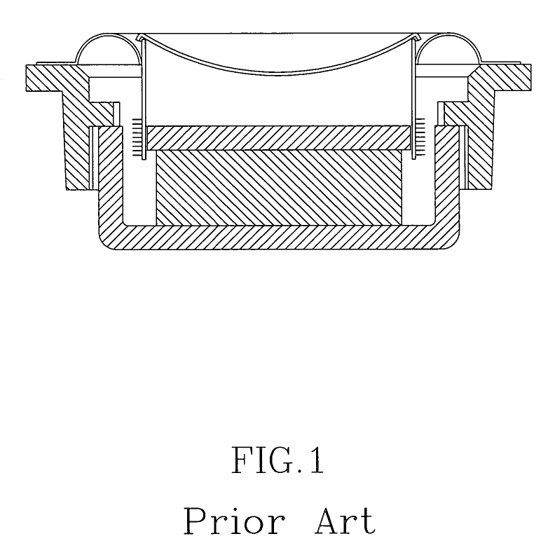

FIG. 2 is a schematic view of a disassembled loudspeaker of the invention;

FIG. 3 is a schematic view of an assembled loudspeaker of the invention;

FIG. 4 is a schematic view of a radial pattern on the surface of a diaphragm according to the present invention;

FIG. 5 is a schematic view of stairway-like through holes on a magnetic circuit according to the invention; and

FIG. 6 is a schematic view of an application of the invention.

### DETAILED DESCRIPTION OF THE PREFERRED EMBODIMENTS

To achieve the foregoing objectives, a loudspeaker structure with a lighting effect comprises a support frame having a magnetic circuit disposed at the bottom of the support frame, a voice coil installed above the magnetic circuit, a diaphragm adhered on the voice coil, and a suspending edge disposed between the diaphragm and the support frame, characterized in that the diaphragm is a thin object pervious to light, and a through hole is constructed separately at the front and rear ends of the magnetic circuit for installing a light emitting device. After the loudspeaker is assembled, the light emitting device is installed in the interior space between the diaphragm and the magnetic circuit. Besides outputting sounds, the loudspeaker also produces a lighting effect, so as to make the manufacture and applications of the loudspeaker more diversified and allow the loudspeaker to have various changes.

To make it easier to understand the contents of the assembly and other characteristics, a preferred embodiment accompanied with the attached drawings are used for a detailed description as follows:

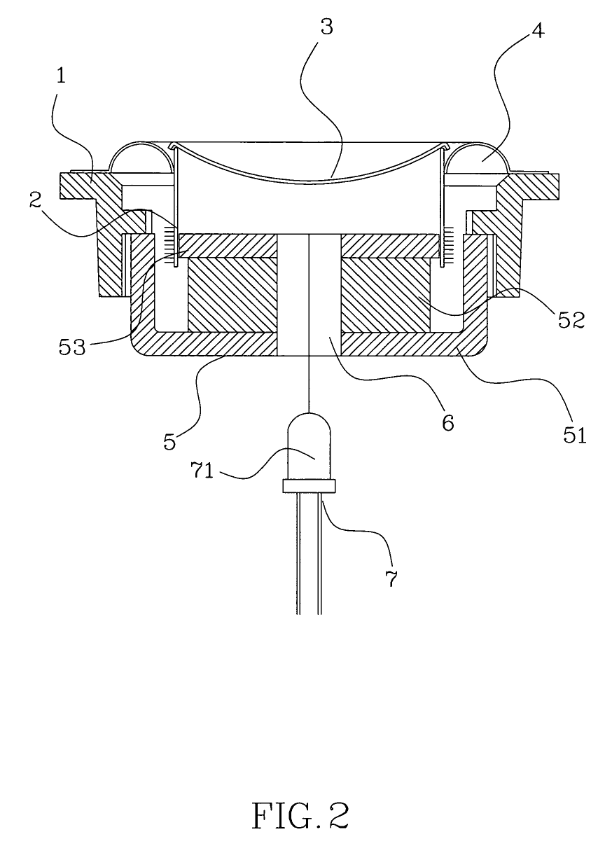

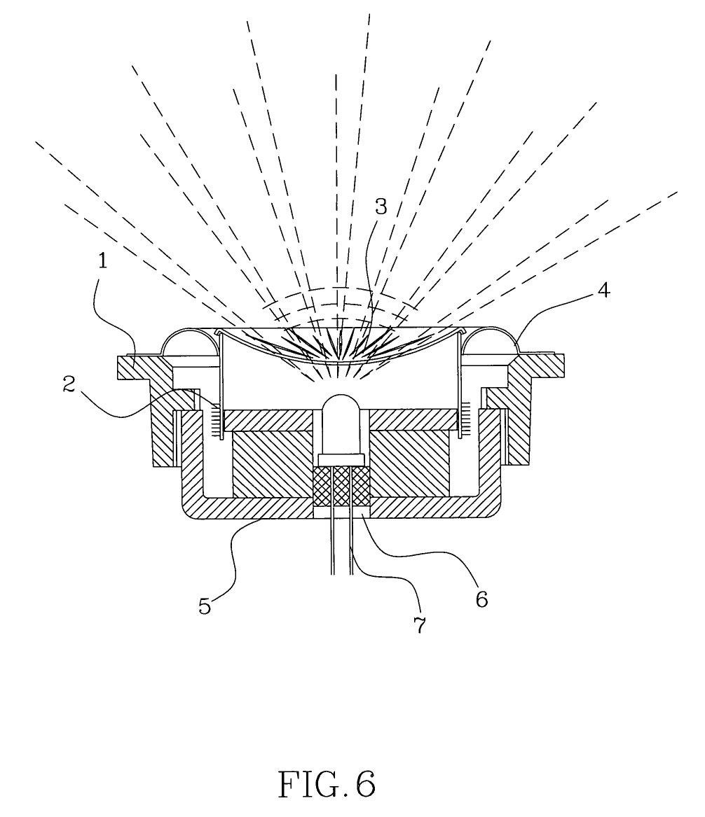

Referring to FIGS. 2 to 6, a loudspeaker structure with a lighting effect comprises:

A support frame 1, having a magnetic circuit 5 at the bottom of the support frame 1;

A voice coil 2, disposed above the magnetic circuit 5;

A diaphragm 3, adhered onto the voice coil 2; and

A suspending edge 4, adhered between the diaphragm 3 and the support frame 1; characterized in that the diaphragm 3 is a thin object pervious to light, and the magnetic circuit 5 has through holes 6 separately disposed at the front and rear ends of the magnetic circuit 5 for installing a light emitting device 7.

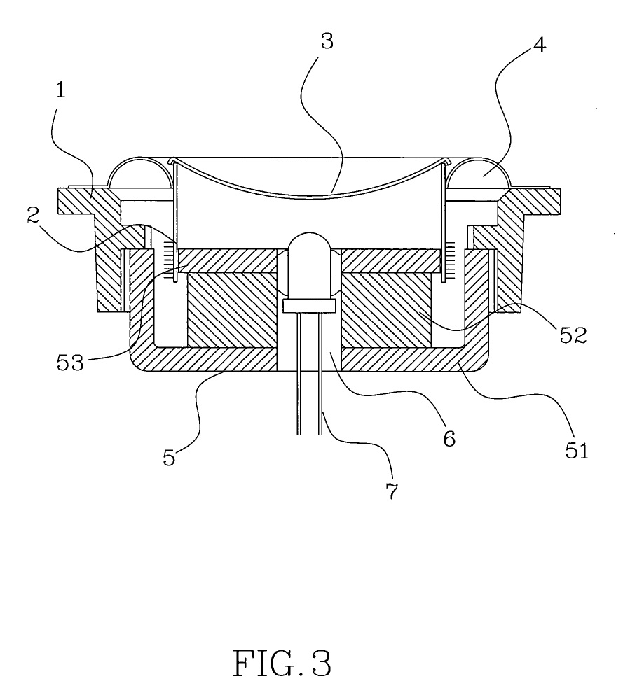

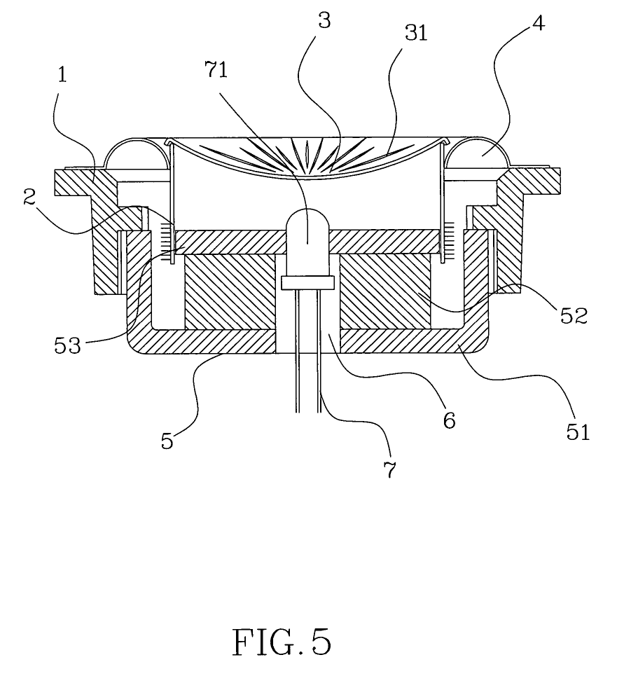

Referring to FIGS. 2 to 4 for the loudspeaker being in use, the magnetic circuit 5 comprises a U-shape circular iron member 51 having a magnet 52 installed therein and being covered by a iron plate 53, and its through holes 6 disposed thereon have equal diameter for passing the circular iron member 51, the magnet 52 and the iron plate 53, such that when the light emitting device 7 is installed, an accessory sleeve 8 installed at the rear end can fill in the through hole 6, or a bulb 71 is adhered into the through hole 6 as shown in FIG. 3, or the through hole 6 on the magnetic circuit 5 could be a stairway-like hole for the manufacture as shown in FIG. 5, so that the iron plate 53 remains at the position with a smaller diameter for inserting the bulb 71 of the light emitting device 7.

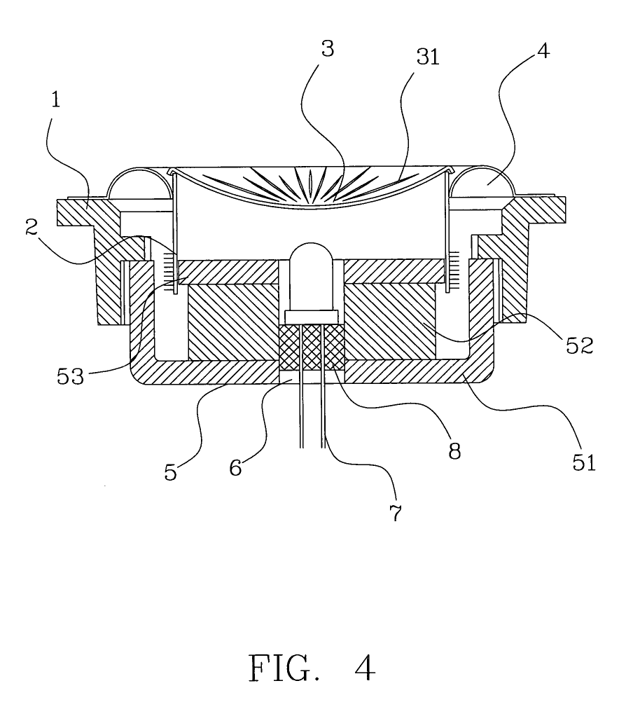

Referring to FIGS. 4 to 6, the light emitting device 7 used for the invention could be a light emitting diode (LED), and the diaphragm 3 is made of a transparent plastic material, and has a radial wavy pattern 31 on the diaphragm 3 to improve the light diffusion effect. When the loudspeaker is assembled, the light emitting device 7 can be installed in the interior space between the diaphragm 3 and the magnetic circuit 5. Besides outputting sounds, the loudspeaker can produce the effect of emitting light from its interior, so as to make the manufacture and applications of the loudspeaker more diversified and allow the loudspeaker to have various changes. The invention integrates sound and light, which can change the intensity of the light according to the volume of the sound, so as to enhance the sound and light effects.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A loudspeaker structure with a lighting effect, comprising:
a support frame, having a magnetic circuit at the bottom of said support frame;
a voice coil, disposed above said magnetic circuit;
a diaphragm, adhered onto said voice coil; and
a suspending edge, adhered between said diaphragm and said support frame; characterized in that said diaphragm is a thin object pervious to light, and said magnetic circuit includes a through hole separately disposed at the front and rear ends of said magnetic circuit for installing a light emitting device, such that when said loudspeaker is assembled, said light emitting device is installed in an interior space between said diaphragm and said magnetic circuit, so as to output sounds as well as producing a lighting effect from the interior of said loudspeaker.

2. The loudspeaker structure with a lighting effect of claim 1, wherein said magnetic circuit comprises a U-shape circular iron member having a magnet therein and covered by an iron plate, and the diameters of said through holes are equal for passing said circular iron member, said magnet and said iron plate.

3. The loudspeaker structure with a lighting effect of claim 1, wherein said magnetic circuit comprises a U-shape circular iron member having a magnet disposed therein and covered by an iron plate, and said through hole is a stairway-like hole for passing said circular iron member, said magnet and said iron plate, and said iron plate is fixed at a position with a small diameter of said through hole.

4. The loudspeaker structure with a lighting effect of claim 1, wherein said light emitting device is a light emitting diode (LED).

5. The loudspeaker structure with a lighting effect of claim 1, wherein said diaphragm is made of a transparent plastic material and has a radial wavy pattern disposed on said diaphragm.
